(19) United States
(12) Patent Application Publication
(10) Pub. No.: US 2017/0030504 A1
(43) Pub. Date: Feb. 2, 2017

(54) Plug For A Pipe Opening

(71) Applicant: Joseph Leslie Robillard, Maple Grove, MN (US)

(72) Inventor: Joseph Leslie Robillard, Maple Grove, MN (US)

(21) Appl. No.: 14/812,547

(22) Filed: Jul. 29, 2015

(51) Int. Cl. F16L 55/11

(52) U.S. Cl. CPC F16L 55/1141

(57) ABSTRACT

Disclosed is a plug that includes a head and a tapered body extending from the head at a first end and terminating in a base at a second end. The tapered body tapers from a first relatively larger diameter near the first end to a second relatively smaller diameter near the base. The tapered body includes an exterior surface that includes annular frusto-conical ridges.

### BACKGROUND

The invention is directed to a plug for sealing a pipe opening.

Clean out plugs are so named because they are used to seal openings that provide access points for cleaning out (e.g., with a snake) a sewer pipe. Clean out plugs are often used to seal floor drains and openings in plumbing stacks.

Floor drains in older houses were often made from cast iron and included a threaded opening. These floor drains were often sealed by screwing a threaded cast iron plug (e.g., a clean out plug) into the drain opening. Today, the threads on these clean out plugs and the threads of the drain opening are often rotted, which makes removing the old clean out plug and inserting a new clean out plug very difficult. Typically it is necessary to use a chisel to pry the plug free from the drain. During this process the plug is destroyed, rotted threads fall into the pipe, and the drain opening is damaged.

When a pipe backs up (e.g., with sewage) there can be standing water and sewage covering the floor drain and the clean out plug. Most people want the water and sewage to go away fast, which means the problem that caused the backup must be identified and fixed as quickly as possible. The water and sewage covering the drain makes finding and removing the clean out plug even more difficult and time consuming.

Once the clean out plug has been removed, the drain must be resealed. However, because the threads on the drain opening have either completely rotted off or have been partially or completely destroyed, a threaded plug can no longer be screwed into the opening. As a result, a replacement plug must be forced into the opening, e.g., by pounding. Many existing replacement plugs are made from cast iron and include a threaded layer of lead. Although these plugs are designed to be threaded in place, they frequently have to be pounded in place due to the lack of threads on the drain pipe opening. When it comes time to remove these plugs, these plugs must also be chiseled out of the opening. This action destroys the utility of the plug and can further damage the drain opening.

It would be desirable to have a plug that can be inserted and removed from a pipe opening without being destroyed and without destroying the pipe opening, and can be reused.

### SUMMARY

In one aspect, the invention features a plug that includes a head, and a tapered body extending from the head at a first end and terminating in a base at a second end, the tapered body tapering from a first relatively larger diameter near the first end to a second relatively smaller diameter near the base, the tapered body including an exterior surface that includes annular frusto-conical ridges. In one embodiment, the annular frusto-conical ridges are in parallel relationship with one another. In other embodiments, at least one of the annular frusto-conical ridges is discontinuous. In some embodiments, the annular frusto-conical ridges are elastomeric. In another embodiment, the annular frusto-conical ridges include elastomer and thermoplastic polymer.

In one embodiment, the body is elastomeric.

In other embodiments, the head includes an arcuate exterior surface.

In another embodiment, the plug further includes a drive nut. In some embodiments, the drive nut is in the shape of a polyhedron. In other embodiments, the drive nut is defined by at least one arcuate side wall.

In some embodiments, the plug further includes an extraction recess. In one embodiment, the extraction recess is defined by an acute angle formed by a first planar surface of the head and a second frusto-conical surface of the head. In other embodiments, the head includes a frusto-conical member and planar member. In another embodiment, the frusto-conical member joins the planar member at an acute angle.

In one embodiment, the tapered body is frusto-conical in shape and includes a diameter that tapers from a relatively larger diameter near the head to a relatively smaller diameter near the base of the body.

In other embodiments, the plug further includes a flange disposed between the head and the body, the flange including a diameter that is greater than a largest diameter of the body.

In another embodiment, the head includes a planar exterior surface. In one embodiment, the plug further includes a drive nut disposed on the planar exterior surface of the head.

The invention features a plug (e.g., clean out plug) for sealing a pipe (e.g., a drain pipe). The invention also features a plug that can be inserted in a pipe opening without damaging the pipe opening, and can be removed from a pipe opening without damaging the plug.

Other features and advantages will be apparent from the following brief description of the drawings, the drawings, the description of the preferred embodiments, and from the claims.

### GLOSSARY

The term “unitary” means indivisible without damage.

### BRIEF DESCRIPTION OF THE DRAWINGS

FIG. 1 is a side view of a plug in accordance with a first embodiment.

FIG. 2 is a top view of the plug of FIG. 1.

FIG. 3 is a bottom view of the plug of FIG. 1.

FIG. 4 is a cut away view of the plug of FIG. 1 in a pipe opening.

FIG. 5 is a side view of a plug according to a second embodiment.

FIG. 6 is a bottom view of the plug of FIG. 5.

FIG. 7 is a side view of a plug according to a third embodiment.

FIG. 8 is a side view of a plug according to a fourth embodiment.

FIG. 9 is a top view of the plug of FIG. 8.

FIG. 10 is a bottom view of the plug of FIG. 8.

FIG. 11 is a side view of a plug according to a fifth embodiment.

FIG. 12 is a top view of the plug of FIG. 11.

FIG. 13 is a side view of a plug according to a sixth embodiment.

FIG. 14 is a top view of the plug of FIG. 13.

FIG. 15 is a side view of a plug that includes annular rings with planar surfaces.

FIG. 16 is a view taken in cross-section of the plug of FIG. 15.

### DETAILED DESCRIPTION

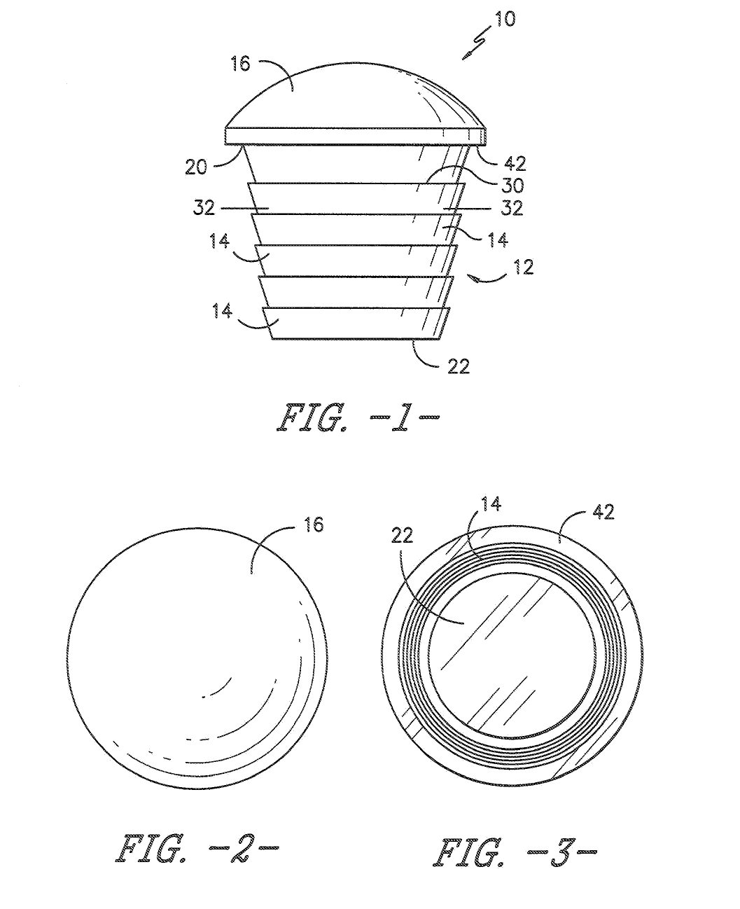

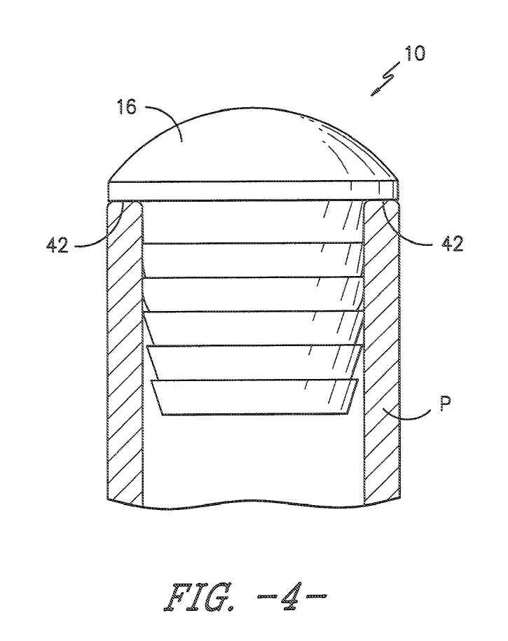

The plug 10 includes a tapered body 12 that includes frusto-conical annular ridges 14, and a head 16, an exemplary embodiment of which is shown in FIGS. 1-4. In use, the body 12 of the plug 10 is positioned in a pipe (P) opening and the head 16 of the plug 10 is then hit with a striking force to force the body 12 of the plug 10 farther into the depth of the pipe (P) to seal the pipe, as shown in FIG. 4. The plug can be removed from the opening by prying the plug out of the opening.

The tapered body 12 of the plug extends from a first end 20 near the head 16 of the plug 10 to a second end 22, which forms the base 22 of the body. The tapered body 12 is circular in cross-section and decreases in diameter along its length from the head 16 to the base 22 such that the diameter of the portion of the body 12 that is near the head 16 is greater than the diameter of the portion of the body 12 at the base 22. The body 12 can be hollow (e.g., tubular), or solid, and can include a solid portion(s) and a hollow portion(s).

The frusto-conical annular ridges 14 are in a parallel relationship with one another and form continuous ridges 14 that extend around the circumference of the body and form the exterior surface of the body. The ridges 14 are adjacent to one another, are positioned in a step-wise fashion along the exterior surface of the body 12, and taper in diameter along the slant length of the body 12 from a point 20 closer to the head 16 of the plug 10 to a point closer to the base 22 of the plug 10. Each ridge 14 tapers in diameter from a ridge crest 30, which is relatively closer to the head 16 of the plug 10, to a ridge base 32, which is relatively closer to the base 22 of the plug 10, such that the diameter of the ridge crest 30 is greater than the diameter of the ridge base 32. The bases 32 of the ridges 14 have smaller diameters relative to the crests 30 of the adjacent ridges 14 such that the ridges form protuberances on the exterior surface on the body 12.

The head of the plug provides a striking surface for driving (e.g., pounding) the plug into position into a pipe. The head 16 includes a bottom wall 42 that functions as a stop when the body of the plug is inserted into a pipe opening. The stop prevents the head from entering the opening of a pipe and prevents the plug body from traveling farther into the length of the pipe and becoming permanently lodged in the pipe. The portion of the head that functions as a stop has a cross-sectional dimension e.g., diameter, that is greater than the cross-sectional dimension of the tapered body near the head. The stop is positioned between the striking surface of the head and the tapered body. The stop can be in the form of a unitary member with the head or can be a separate component (e.g., a separate collar or a flange).

When it is time to remove the plug 10 from the pipe opening, a lever (e.g., the flat end of a flat screw driver or a chisel) can be inserted between the bottom wall 42 of the head 16 and the pipe (or surface surrounding the pipe (e.g., a cement floor), if present) and a levering force can be applied against the bottom wall 42 of the head 16 and the pipe to pry the plug 10 out of the pipe. The bottom wall 42 of the head 16 preferably extends from the body 12 of the plug 10 an amount sufficient to enable a lever, when placed between the bottom wall 42 of the head 16 and the surface defining the mouth of the pipe, to apply a levering force to the head 16 of the plug 10.

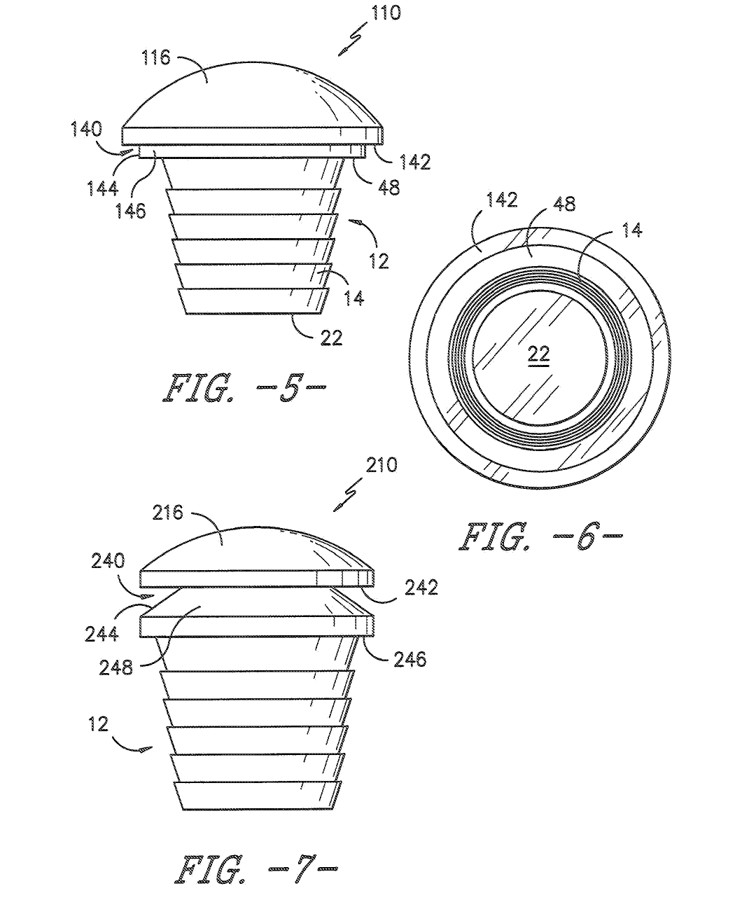

In other embodiments, the plug includes an extraction recess. An extraction recess can assist in the removal of the plug from a pipe by creating a surface against which a force, e.g., a levering force, can be applied. In one exemplary embodiment, the plug 110 includes a head 116, a stop 146 that includes a side wall 144 and a bottom wall 48, ridges 14 extending around the body of the plug, and a base 22, as shown in FIGS. 5 and 6. An extraction recess 140 is defined by the bottom wall 142 of the head 116 and the side wall 144 of the stop 146. When it is time to remove the plug 110 from the pipe opening, a lever (e.g., the flat end of a flat screw driver or a chisel) can be inserted into the extraction recess 140 and a levering force can be applied against the bottom wall 142 of the head 116 to pry the plug 110 out of the pipe. Optionally, or in addition, the pipe surface (e.g., the surface of a plumbing stack) or a floor surface, where available (e.g., where the plug is a clean out plug and the opening is an opening in a floor drain), can function as a fulcrum. A levering force can be applied against the fulcrum, the bottom wall of the head, or a combination thereof in an attempt to pry the plug out of the pipe opening.

FIG. 7 illustrates another embodiment of a plug 210 that includes an extraction recess 240. The head 216 is arcuate in shape and includes a frusto-conical portion 248 that forms a stop. The frusto-conical portion 248 includes a tapered, exterior side wall 244 and a bottom wall 246. The frusto-conical portion 248 forms a truncated cone that extends from a relatively smaller diameter near a bottom wall 242 of the head 216 to a relatively larger diameter near the plug body 12. The extraction recess 240 is defined by the side wall 244 of the frusto-conical portion 248 and a planar bottom wall 242 of the arcuate head 216.

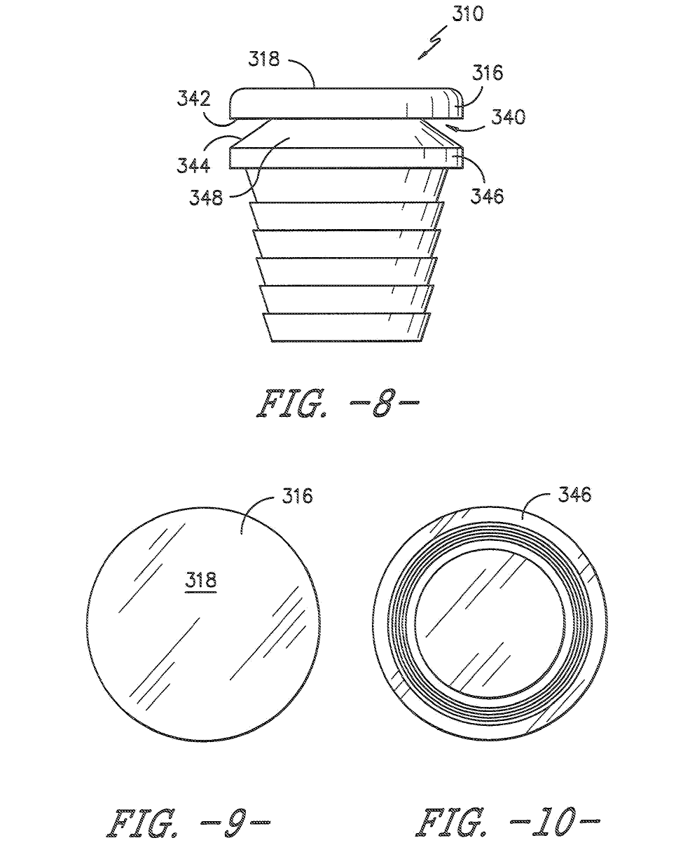

FIGS. 8-10 illustrate another embodiment of a plug 310 that includes an extraction recess 340. In this embodiment, the head 316 includes a top exterior surface 318 that is planar, a bottom wall 342 that is planar, and a frusto-conical portion 348 that terminates in a stop 346. The extraction recess 340 is defined by an exterior surface 344 of the frusto-conical portion 348 of the head 316 and the planar bottom wall 342 of the head 316.

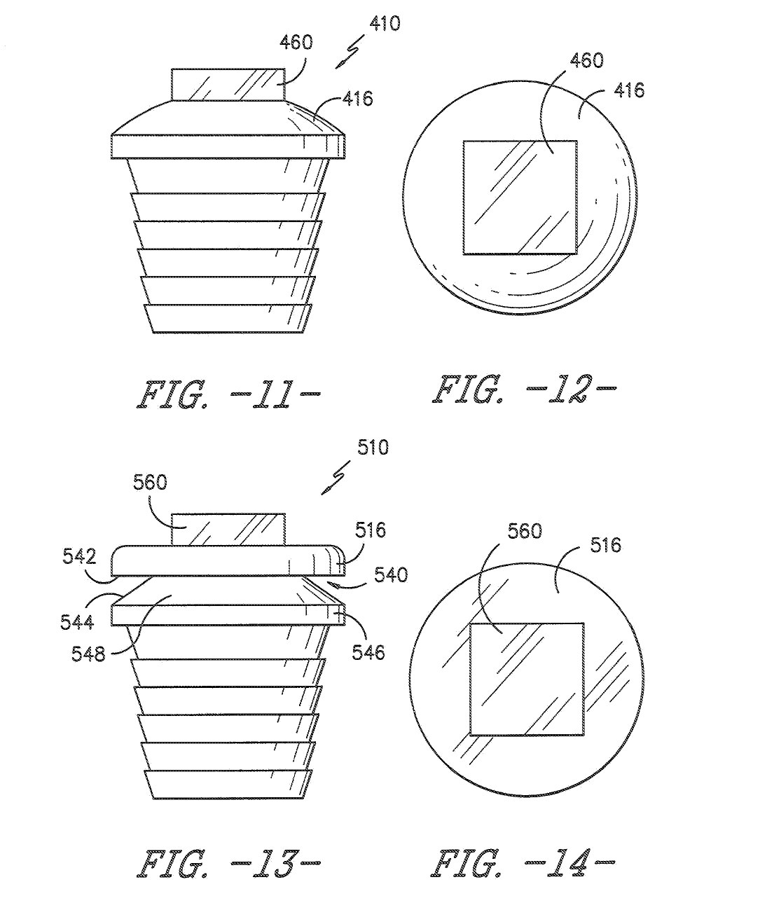

The plug optionally includes a drive nut. A drive nut provides a surface for striking the head of the plug to force the plug into the depth of the pipe. The drive nut can be of a variety of shapes and sizes including, e.g., polyhedral (e.g., triangular, square, pentagonal, hexagonal, and octagonal) having any number of planar side walls (e.g., three, four, five six, seven, eight, nine, and ten), and arcuate (e.g., having at least one arcuate side wall (e.g., circular (e.g., hemispherical and spherical) and elliptical)). FIGS. 11-14 illustrate an exemplary embodiment of a plug 410 that includes a drive nut 460. The drive nut 460 is in the shape of a cube and is located on the arcuate head 416 of a plug 410.

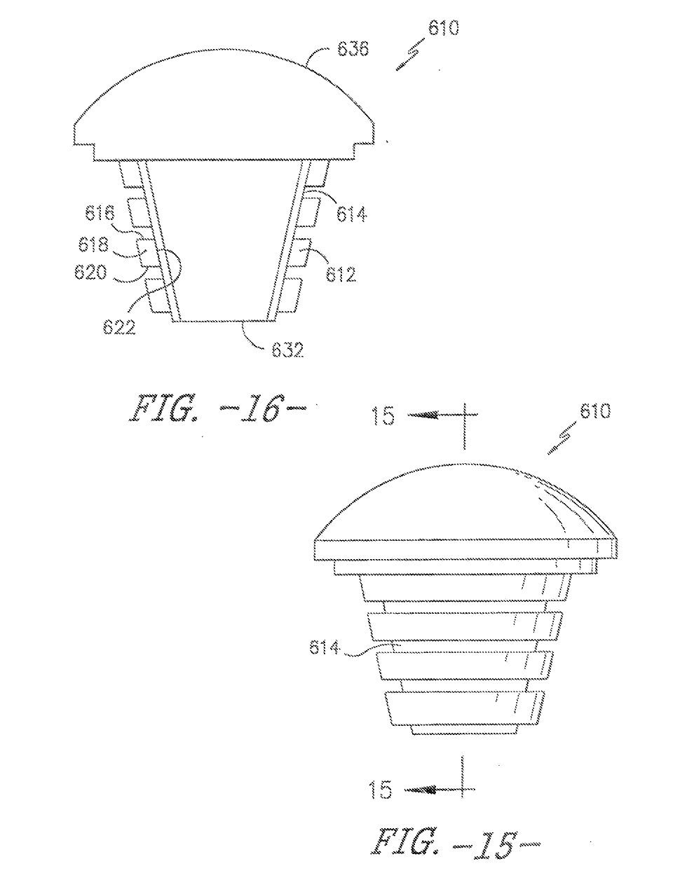

In another embodiment, a cubic drive nut 560 is attached to the planar exterior surface of the head 516 of the plug 510, as shown in FIGS. 13 and 14. In this embodiment, the head includes a frusto-conical portion 548 that terminates in a stop 546. The plug 510 also includes an extraction recess 540 defined by the exterior surface 544 of the frusto-conical portion 548 of the head 516 and a planar bottom wall 542 of the head 516.

The plug can be made from any suitable material including, e.g., plastic, elastomer, metal (e.g., alloy), and combinations thereof, and can exhibit a variety of properties including, e.g., being conformable, expandable, pliable, flexible, elastomeric, rigid, and combinations thereof. The components of the plug can be made from the same material or different materials and can be a unitary plug (i.e., each of the components of the plug are indivisible from each other such that an attempt to remove one component from the plug would destroy the plug, a component of the plug, or the function of the plug as a whole) or multiple components that are affixed together (e.g., through a mechanical device (e.g., a screw or a bolt)). The plug preferably is constructed from a material that enables it to withstand removal and insertion forces such that it can be reused.

The body, including the ridges, preferably is made from a material that will enable the body to conform slightly to, and form a friction fit seal with, the interior surface of the pipe. Useful materials from which the body and the ridges can be made include, e.g., elastomer (e.g., natural rubber, polyisoprene, polybutadiene, polychloroprene, butyl rubber, nitrile rubber, styrene-butadiene, styrene-butadiene-styrene, styrene-isoprene-styrene, hydrogenated versions of the same, ethylene-propylene-diene rubber, ethylene vinyl acetate, fluoroelastomers, and combinations thereof), polyolefin (e.g., polyethylene (e.g., high density polyethylene and low density polyethylene), polypropylene, polybutene, polyhexene, polyoctene, and combinations thereof), polystyrene, vinyl polymers and copolymers (e.g., polyvinyl chloride), metals (e.g., iron, steel, copper, metal alloys, and combinations thereof), and combinations thereof.

The body also can be of any suitable dimension. The body preferably has a diameter that is suitable for insertion into and closing or sealing of the pipe opening that is to be closed or sealed. Examples of useful body diameters include, e.g., at least about 1 inch (in), at least about 1.25 in, at least about 1.5 in, from about 1.25 in to about 5 in, from about 1.25 in to about 4.5 in, or even from about 1.25 in to about 4 in.

The head also can be of any suitable dimension, can be made in a variety of shapes and sizes including, e.g., arcuate, planar, and combinations thereof, and can be made from any suitable material. The head preferably is dimensioned to have a cross-sectional dimension that is larger than the diameter of the body. In use, the cross-sectional dimension of the head preferably is sufficiently larger than the opening in the pipe into which the plug is to be inserted so as to prevent (i.e., stop) the plug from becoming fully inserted in the pipe.

The head preferably is made from a material that can withstand the pounding force necessary to pound the plug into a pipe opening. Useful materials include the materials described above with respect to the body of the plug. The walls defining the extraction recess preferably are of a material and a dimension sufficient to withstand the force necessary to lever the plug from the pipe opening.

The plug can be used to close (e.g., seal) an opening in a pipe that carries a liquid such as water, waste water, or sewage. The plug is particularly useful as a clean out plug for use in floor drains and plumbing stacks. The plug can be used in pipes made from a variety of materials including, e.g., metal (e.g., cast iron, steel, copper, and combinations and alloys thereof), polymer (e.g., polyvinyl chloride, chlorinated polyvinyl chloride, polyethylene (e.g., crosslinked polyethylene), polypropylene, polybutene, polyester, polybutylene terephthalate, polyterephthalate, and combinations thereof), and combinations thereof.

Other embodiments are within the claims. Although the ridges have been described as being frusto-conical, in other embodiments the ridges are in the form of annular rings surrounding the body of the plug. Suitable annular rings include solid, hollow, and filled rings, and combinations thereof. The annular rings can have a variety of cross-sectional configurations including, e.g., circular, elliptical, hemispherical, rhombohedral, and polygonal (e.g., square, rectangular, and triangular) In some configurations, the annular ring substantially exhibits an aforementioned shape and includes a tapered side wall that defines the interior diameter of the annular ring. FIGS. 15 and 16 illustrate one embodiment of a plug 610 that includes annular rings 612 surrounding the plug body 614 and forming the ridges of the plug 610. The annular rings 612 have three exterior side walls 616, 618, 620 that are at angles to one another and a third side wall 622 that is tapered, which combine to form a rhombohedral ring. The interior diameter of the rings 612 taper from a first narrower (i.e., smaller) diameter closer to the base 632 of the plug to a wider (i.e., larger) diameter closer to the head 636 of the plug 610.

The ridges can be continuous or discontinuous and a single plug can include both continuous and discontinuous ridges and a plug can include any number of ridges including, e.g., two, three, four, five, six, and seven.

What is claimed is:

1. A plug comprising:
a head; and
a tapered body extending from the head at a first end and terminating in a base at a second end, the tapered body tapering from a first relatively larger diameter near the first end to a second relatively smaller diameter near the base, the tapered body comprising an exterior surface comprising annular frusto-conical ridges.

2. The plug of claim 1, wherein the annular frusto-conical ridges are in parallel relationship with one another.

3. The plug of claim 1, wherein at least one of the annular frusto-conical ridges is discontinuous.

4. The plug of claim 1, wherein the annular frusto-conical ridges are elastomeric.

5. The plug of claim 1, wherein the annular frusto-conical ridges comprise elastomer and thermoplastic polymer.

6. The plug of claim 1, wherein the body is elastomeric.

7. The plug of claim 1, wherein the head comprises an arcuate exterior surface.

8. The plug of claim 1 further comprising a drive nut.

9. The plug of claim 8, wherein the drive nut is in the shape of a polyhedron.

10. The plug of claim 8, wherein the drive nut is defined by at least one arcuate side wall.

11. The plug of claim 1 further comprising an extraction recess.

12. The plug of claim 1, wherein the extraction recess is defined by an acute angle formed by a first planar surface of the head and a second frusto-conical surface of the head.

13. The plug of claim 1, wherein the head comprises a frusto-conical member and planar member.

14. The plug of claim 13, wherein the frusto-conical member joins the planar member at an acute angle.

15. The plug of claim 1, wherein the tapered body is frusto-conical in shape and comprises a diameter that tapers from a relatively larger diameter near the head to a relatively smaller diameter near the base of the body.

16. The plug of claim 1 further comprising a flange disposed between the head and the body, the flange comprising a diameter that is greater than a largest diameter of the body.

17. The plug of claim 1, wherein the head comprises a planar exterior surface.

18. The plug of claim 16 further comprising a drive nut disposed on the planar exterior surface of the head.
